(19) United States
(12) Patent Application Publication
(10) Pub. No.: US 2004/0194323 A1
(43) Pub. Date: Oct. 7, 2004

(54) Eating utensil having pressure pad

(76) Inventor: William J. Lueck, Pequot Lakes, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/781,246

(22) Filed: Feb. 18, 2004

Related U.S. Application Data
(60) Provisional application No. 60/459,492, filed on Apr. 1, 2003.

(51) Int. Cl. A47J 43/28

(52) U.S. Cl. 30/323

(57) ABSTRACT

An eating utensil pressure pad which relieves pressure imposed upon a utensil user's finger(s) when attempting to cut food. The eating utensil comprises an elongated handle having an implement disposed upon the handle and an pressure pad circumferentially surrounding the eating utensil handle at a location near the distal end of the handle. The pressure pad comprises a body with opposing front and back surfaces; opposing top and bottom sides; and opposing left and right sides. The top and bottom sides of the body have openings forming a slot in an interior portion of the body, whereby the slot extends throughout the body for acceptance of an eating utensil handle. The left and right sides are recessed, so as to accommodate one or more digits of a user's hand, thereby reducing pressure subjected to user's digits when manipulating the eating utensil.

### CROSS REFERENCE TO RELATED APPLICATIONS

This application claims the benefit of U.S. Provisional Application Ser. No. 60/459,492, filed on Apr. 1, 2003.

### FIELD OF THE INVENTION

The invention relates to a pad for an eating utensil such as a fork, or the like, for relieving pressure that is applied to a user's finger while attempting to cut food with a side of the utensil.

### BACKGROUND OF THE INVENTION

Various eating utensil attachments have been made to aid a user in manipulating the utensil. However, most of these attachments are directed to knives, and lack the ability to improve user comfort during the manipulation and use of the utensil employing the device.

Use of a fork while eating often requires the user to apply the fork to cut or break apart a portion of food. Typical forks have a relatively long and thin handle with the tines at one end, which necessitates gripping the fork by the user's thumb, forefinger and middle finger in order to cut or break apart food. This action requires a user to turn the fork on its side, place at least one finger on the side-edge of the fork, and apply force with the finger(s) allowing the fork to cut the food. To execute this action, a degree of finger dexterity and mobility is required. Certain individuals, such as small children, adults with motor skill disabilities, or individuals suffering from various ailments such as arthritis, carpal tunnel and other types of inflammation of the finger joints can find it difficult or even painful to grip such a thin, elongated handle with their fingers, particularly when extra pressure is required for cutting.

Furthermore, due to the small surface area of the side-edge of the typical fork handle, a user's finger can easily slip while applying force. A fork that slips from an eater's unsteady gripping position can injure an eater or create a mess on the eater's clothes, table or floor.

It is well known that eating establishments are often sites of advertising and promotion for the suppliers of various products such as alcoholic beverages and sport franchises. For example, a tavern or a bowling alley, both prime establishments for serving pizza (which is commonly eaten by cutting with a fork), typically display numerous advertisements promoting various brands of beverages in the form of trademarks displayed on such things as drinking glasses, coasters, neon signs, and posters. Marketers are always looking for new and unique mediums for their advertising.

While there are patents that address various implements for improving the maneuverability and control of knives, there remains a need for an eating utensil pressure pad that not only assists the user when manipulating and applying pressure on the side-edge of a fork handle during cutting operations, but also molds to the fingers of the user and gives the user immediate comfort and ease of use when applying such necessary force.

### BRIEF SUMMARY OF THE INVENTION

The above needs are met by the present invention which provides an pressure pad that is affixed to the elongated handle of an eating utensil. As such, it is an object of the present invention to provide an pressure pad which relieves pressure that is imposed upon a utensil user's finger(s) when attempting to cut food with a fork, or other similar eating utensil. For example, when a user turns a fork on its side to cut or break apart a portion of food, at least one finger is placed on a side edge of the fork handle. When the user presses down on the food, much of the force applied to cut the food is projected on the finger(s) placed at the side edge of the fork. This process can be painful and may cause some injury to the user's finger(s). Thus, the pad attempts to minimize the pressure on the fingers, and provide larger surface upon which the user may apply force.

This invention in the preferred embodiment includes an eating utensil, having an elongated handle with both a proximal and a distal end, and an implement disposed upon the handle. An pressure pad circumferentially surrounds the handle of the eating utensil at a location near the distal end of the handle. The eating utensil pressure pad has a body with opposing front and back surfaces, top and bottom sides, and left and right sides. The left and right sides are recessed, so as to accommodate a user's finger. The top side and the bottom side of the body have openings, which form a slot in the interior portion of the body. This slot extends throughout the body of the pressure pad for acceptance of an eating utensil handle. The eating utensil is preferably a fork, although the pressure pad can be utilized with a variety of eating utensils, such as a spoon. The pressure pad preferably permanently surrounds the elongated handle of the utensil, although it may alternatively be removable. The pressure pad can be of any shape, and preferably has curved or concave sides conforming to a user's finger to better accommodate gripping, and preferably has relatively large front and back surfaces. The front and back surfaces permit the application of logos or other marketing material. The pressure pad is made of hard plastic, however, it may alternatively be made of other more compressible or flexible material.

One aspect of the present invention provides an eating utensil, such as a fork or a spoon, having a handle, an implement attached to an end of the handle, and a pad circumferentially surrounding a portion of the handle and including a lumen through which the handle extends. The pad may be permanently attached to the handle, or removably attached to the handle. Preferably the pad is made of a soft plastic or rubber material.

Another aspect provides an eating utensil having a pad wherein the pad includes at least one surface constructed and arranged to accommodate indicia. The pad may also be shaped to include at least one recess formed to accommodate one or more digit of a user, thereby lessening pressure felt by the one or more digit during use.

Another aspect of the present invention provides a method of cutting food using an eating utensil that includes the steps of first providing an eating utensil having a handle, an implement attached to an end of the handle, and a pad circumferentially surrounding a portion of the handle proximal the implement; and second orienting the implement such that a side surface of the implement is approximately normal to a surface of the food; and finally pressing on the pad with a digit in a direction toward the food, thereby creating a cutting force between the side of the implement and the surface of the food.

This method may be used with an eating utensil such as a fork or spoon. Also, the pad may be permanently or removably fixed to a portion of the handle. The pad may also have an hourglass shape for increased comfort and control. Additionally, the pad may have at least one surface constructed and arranged to accommodate indicia, such as advertising, a promotional message, personalization, or any other suitable markings.

The foregoing and other objects, features and advantages of the invention will become more readily apparent from the following detailed description of a preferred embodiment of the invention that proceeds with reference to accompanying drawings.

### BRIEF DESCRIPTION OF THE DRAWINGS

FIG. 1 is a perspective view of a fork with the affixed eating utensil pressure pad and how it might be held by a user.

FIG. 2 is an end view according to FIG. 1.

FIG. 3 is a side view of the fork with the affixed pressure pad according to FIG. 2.

FIG. 4 is a top view of the fork according to FIG. 1.

FIG. 5 is a perspective view of the embodiment of FIG. 1 in operation used to cut food.

### DETAILED DESCRIPTION OF THE INVENTION

The drawings illustrate an eating utensil pressure pad according to the present invention. Although the eating utensil is a fork in the illustrated embodiment, it will be understood that the pressure pad may alternatively be used for other types of eating utensil, such as a spoon.

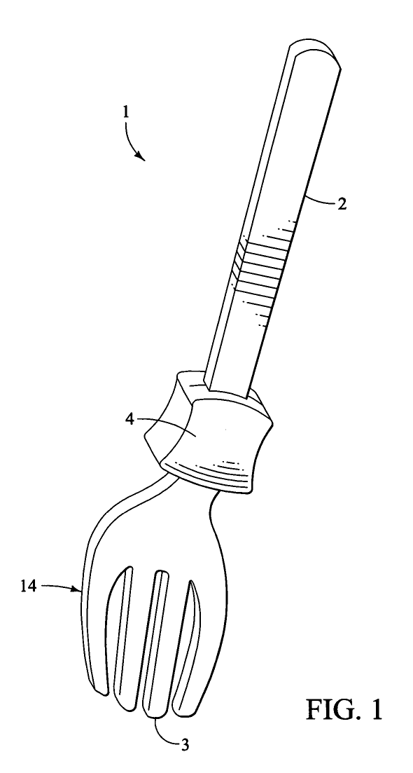

Referring to FIG. 1 of the drawings, the eating utensil 1 shown is a fork with an elongated handle 2 and a plurality of tines 3 disposed on the distal end of the handle 2. An pressure pad 4 is affixed to the distal end of the handle 2 spaced apart from the tines 3.

Although a dinner fork is shown FIG. 1, it should be understood that the present invention can be utilized with a variety of eating utensils 1, such as a spoon. Insofar as the handles of various eating utensils, of a given set, are substantially the same, the function of the utensil 1 is defined by that portion extending from the distal end of the handle 2. This portion of the utensil 1 will hereinafter be referred to as the implement 14.

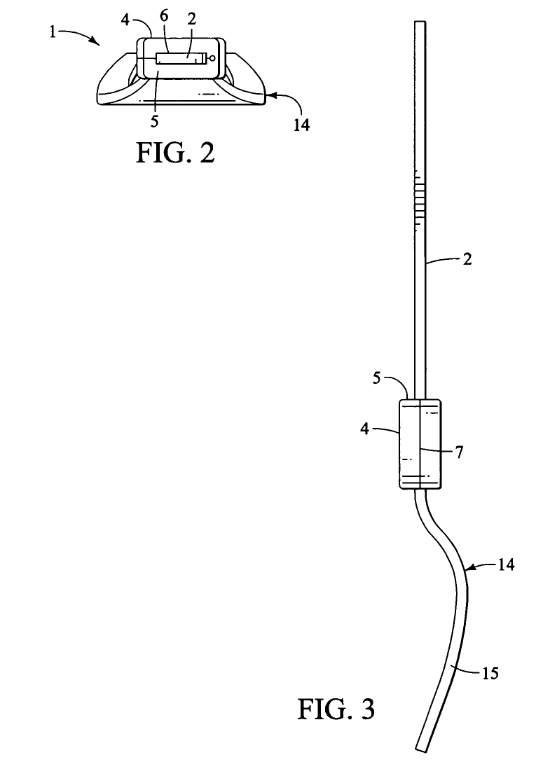

Referring to FIG. 2, the pressure pad 4 circumferentially surrounds the elongated handle 2 of the eating utensil 1. The body of the pressure pad 4 contains both a bottom side [not shown], as well as an opposing top side 5, and defines a lumen 6 extending from the bottom side to the top side 5 through the body. The lumen 6 is large enough to accommodate the handle 2 of an eating utensil 1. Preferably, the pressure pad 4 is formed from a resilient material, such as a soft rubber, foam rubber, soft plastic, or resin, such that the lumen may be stretched over the end of the handle 2, especially in the case of a handle 2 having an ornate or otherwise flared end. Alternatively, the pressure pad 4 can be made of a hard plastic or another rigid material that allows for a more permanent connection between the pressure pad 4 and the handle 2 of the eating utensil 1.

As shown in FIGS. 3-5, the pressure pad 4 has recessed left and right sides 7. The sides 7 of the pressure pad 4 can be of any shape, including curved or concave sides, that accommodate gripping and conforms to a user's finger.

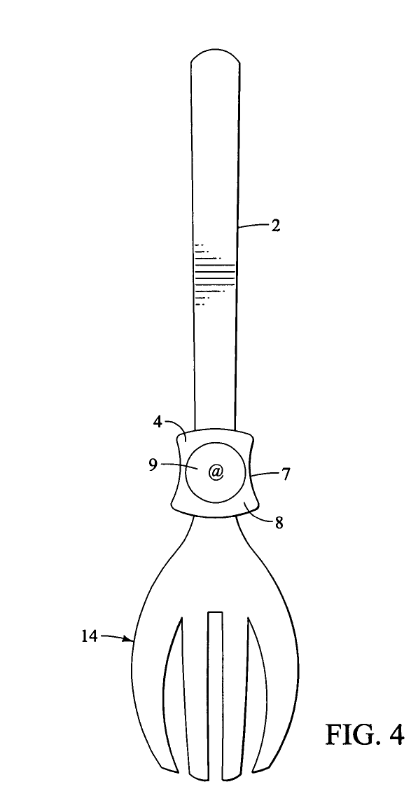

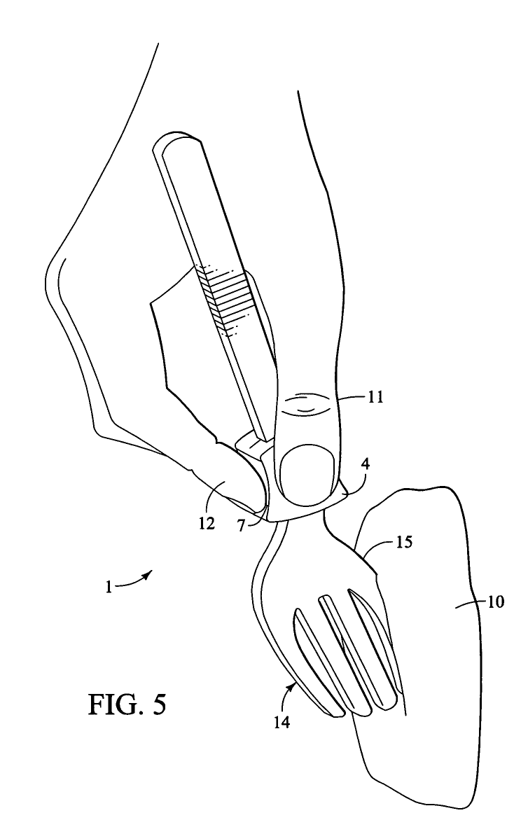

As shown in FIG. 4, the pressure pad 4 is constructed such that front surface 8 is relatively large. The opposing back surface is equal in size to the front surface 8 of the pressure pad 4. Thus, the front surface 8, as well as the back surface of the pressure pad 4 may include indicia 9 which consists of advertising matter which may include, for example, the names of restaurants, sports teams, beer and liquor logos, or the like.

As shown in FIG. 5, the eating utensil 1 is handled by the user to cut apart food 10. The user grips the eating utensil 1 with the user's thumb 11 and forefinger 12. The recessed side 7 of the pressure pad 4 supports the user's forefinger 12.

The shape of the pressure pad 4 may be any shape that accommodates gripping. It should be noted that the while grasping the eating utensil, the user predominately utilizes the thumb, forefinger and middle finger of the user's hand. In the preferred embodiment, as shown in FIG. 5, the recessed side 7 of the hourglass-shaped pressure pad 4 accommodates the tip of the forefinger 12 of the user.

In operation, the eating utensil 1 of the present invention is used by orienting the utensil 1 such that the implement 14 contacts the food 10 with a side surface 15, having a relatively small surface area. The food 10 is then cut by pressing on the pad 4 with a digit in a direction toward the food 10, thereby creating a cutting force between the side surface 15 of the implement and the surface of the food 10. The side surface 15 of the utensil 1 is unsharpened, thereby protecting the mouth of the user, but requiring additional force to use cut food 10 with the side 15.

The invention has herein been described in its preferred embodiments to provide those skilled in the art with the information needed to apply the novel principles and to construct and use the embodiments of the examples as required. However, it is to be understood that the invention can be carried out by specifically different devices and that various modifications can be accomplished without departing from the scope of the invention itself, which is set out in the following claims:

What is claimed is:

1. An eating utensil comprising:
a handle;
an implement attached to an end of the handle;
a pad circumferentially surrounding a portion of the handle and including a lumen through which the handle extends.

2. The eating utensil of claim 1 wherein the pad is permanently attached to the handle.

3. The eating utensil of claim 1 wherein the pad is removably attached to the handle.

4. The eating utensil of claim 1 wherein the implement comprises a plurality of tines.

5. The eating utensil of claim 1 wherein the implement comprises a spoon.

6. The eating utensil of claim 1 wherein the pad comprises plastic.

7. The eating utensil of claim 1 wherein the pad further includes at least one surface constructed and arranged to accommodate indicia.

8. The eating utensil of claim 1 wherein the pad further includes at least one recess formed to accommodate one or more digit of a user, thereby lessening pressure felt by the one or more digit during use.

9. A method of cutting food using an eating utensil comprising:
providing an eating utensil having a handle, an implement attached to an end of the handle, and a pad circumferentially surrounding a portion of the handle proximal the implement;
orienting the implement such that a side surface of the implement is contacting the food;
pressing on the pad with a digit in a direction toward the food, thereby creating a cutting force between the side of the implement and the surface of the food.

10. The method of claim 9 wherein the step of providing an eating utensil comprises providing a fork having a handle, an implement attached to an end of the handle, and a pad circumferentially surrounding a portion of the handle proximal the implement.

11. The method of claim 9 wherein the step of providing an eating utensil comprises providing an eating utensil having a handle, an implement attached to an end of the handle, and a pad circumferentially surrounding and permanently fixed to a portion of the handle proximal the implement.

12. The method of claim 9 wherein the step of providing an eating utensil comprises providing an eating utensil having a handle, an implement attached to an end of the handle, and a pad circumferentially surrounding and removably attached to a portion of the handle proximal the implement.

13. The method of claim 9 wherein the step of providing an eating utensil comprises providing an eating utensil having a handle, an implement attached to an end of the handle, and a pad circumferentially surrounding a portion of the handle proximal the implement, and having an hourglass shape.

14. The method of claim 9 wherein the step of providing an eating utensil comprises providing an eating utensil having a handle, an implement attached to an end of the handle, and a pad circumferentially surrounding a portion of the handle proximal the implement, and having at least one surface constructed and arranged to accommodate indicia.

15. An eating utensil comprising:
a handle;
an implement attached to one end of the handle;
a means for relieving pressure on a portion of a hand of a user when the user is using an unsharpened surface of the implement to cut food.

16. The eating utensil of claim 15 wherein said means for relieving pressure is operably attached to the handle.

17. The eating utensil of claim 15 wherein said means for relieving pressure circumferentially surrounds the handle.

18. The eating utensil of claim 15 wherein said means for relieving pressure is constructed and arranged to accommodate indicia.

19. The eating utensil of claim 15 wherein said means for relieving pressure includes at least on recess for accepting a digit of the user.

20. The eating utensil of claim 15 wherein said means for relieving pressure comprises plastic.
